(19) United States
(12) Patent Application Publication
(10) Pub. No.: US 2004/0057225 A1
(43) Pub. Date: Mar. 25, 2004

(54) Fuse

(75) Inventors: Norihiro Ohashi, Haibara-gun (JP); Masashi Iwata, Haibara-gun (JP); Toshiko Masuda, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 10/614,046

(22) Filed: Jul. 8, 2003

(30) Foreign Application Priority Data
Jul. 12, 2002 (JP) P2002-204108

(51) Int. Cl. H02B 1/18; H01H 85/20

(52) U.S. Cl. 361/833

(57) ABSTRACT

A fuse includes a fuse element contained in an insulating housing made of synthetic resin. The insulating housing which includes a pair of housing bodies and an upper wall portion mutually connecting upper ends of the housing bodies is adapted to cover inner edges and upper edges of flat plate terminal portions and a fusible portion. On one side edge of a slit opening formed at a lower end of the insulating housing, a flap is continuously provided through a thin-walled hinge so as to freely rotate. The flap is rotated to a closed position in a state where the fuse element has been inserted into the insulating housing, and locked to locking projections which are projected from the inner edges of the respective flat plate terminal portions. The distal end edge of the flap which is abutted against the other side edge of the slit opening is joined by ultrasonic welding, thermal welding or the like.

The present application is based on Japanese Patent Application No. 2002-204108, which is incorporated herein by reference.

### BACKGROUND OF THE INVENTION

1. Field of the Invention

The present invention relates to a fuse, and more particularly, to a blade type fuse which includes a fuse element having a fusible portion provided between a pair of flat plate terminal portions arranged in parallel, the fuse element being incorporated in an insulating housing.

2. Related Art

A conventional fuse 1 as illustrated in FIG. 5 is a blade type fuse of low height which includes a fuse element 3 having a fusible portion 5 provided between a pair of flat plate terminal portions 4, 4 arranged in parallel, and an insulating housing 2 made of synthetic resin which contains the fuse element 3.

The aforesaid flat plate terminal portions 4 are respectively formed in a substantially rectangular shape, and the aforesaid fusible portion 5 is provided between these flat plate terminal portions 4, 4 so as to laterally bridge their opposed inner edges 4a, 4a.

The aforesaid insulating housing 2 which includes a pair of housing bodies 2a, 2a and an upper wall portion 2c mutually connecting upper ends of the housing bodies 2a, 2a is adapted to cover the inner edges 4a and upper edges 4c of the aforesaid flat plate terminal portions 4 and the aforesaid fusible portion 5.

As shown in FIG. 6, on one side edge of a slit opening 6 formed at a lower end of the aforesaid insulating housing 2, a flap 2b which is integrally formed with the housing through a thin-walled hinge 8 is continuously provided so as to freely rotate.

This flap 2b is rotated to a closed position in a state where the fuse element 3 has been inserted into the insulating housing 2 from the aforesaid slit opening 6, and locked to locking projections 4b which are projected from the aforesaid inner edges 4a of the respective flat plate terminal portions 44 thereby to be held in the closed position.

In this manner, according to the fuse 1, the flat plate terminal portions 4, 4 are held in the insulating housing 2, and so, concentration of outer forces to the fusible portion 5 will be prevented.

However, in the above described conventional fuse 1, the flap 2b of the insulating housing 2 is connected to one of the housing bodies 2a only through the thin-walled hinge 8 at its base end side, while its distal end side is just abutted against a lower end edge 7 of the other housing body 2a.

Therefore, there has been such probability that in case where an outer force has been applied to the aforesaid flap 2b in a direction to open it, the flap 2b rides over the aforesaid locking projections 4b and becomes unable to protect the fusible portion 5.

There has been another problem that the aforesaid insulating housing 2 has an open structure in section in which the upper ends of a pair of the housing bodies 2a, 2a are mutually connected through the upper wall portion 2c, and so, it has been difficult to enhance strength of the insulating housing and to improve protecting performance for the fusible portion 5.

### SUMMARY OF THE INVENTION

In view of the above, an object of the present invention is to solve the above described problems, and to provide a favorable fuse in which deformation of a flap due to outer forces will be prevented and strength of an insulating housing can be enhanced.

The above described object of the invention is attained by a fuse comprising a fuse element which includes a fusible portion provided between inner edges of a pair of flat plate terminal portions arranged in parallel, and an insulating housing which includes a pair of housing bodies and an upper wall portion mutually connecting upper ends of the housing bodies, and covers the inner edges and upper edges of the aforesaid flat plate terminal portions and the aforesaid fusible portion, characterized in that on one side edge of a slit opening formed at a lower end of the aforesaid insulating housing, a flap which is integrally formed with the housing through a thin-walled hinge is continuously provided so as to freely rotate, and a distal end edge of the aforesaid flap is joined to the other side edge of the aforesaid slit opening, in a state where the aforesaid fuse element has been inserted into the insulating housing.

According to the above described structure, because the flap which is integrally formed at the lower end of one of the housing bodies through the thin-walled hinge is joined to the lower end edge of the other housing body at its distal end edge, the flap can be reliably held in a closed state.

Therefore, in case where an outer force has been applied to the aforesaid flap, the flap will not be displaced nor deformed so as to be easily opened, and the fusible portion can be reliably protected.

Moreover, because the slit opening formed at the lower end of the aforesaid insulating housing is reliably closed with the aforesaid flap which is joined at its distal end edge, the insulating housing will have a closed structure in section, and thus, strength of the insulating housing will be enhanced.

Further, the distal end edge of the aforesaid flap is preferably joined to the other side edge of the aforesaid slit opening by welding or by means of at least one locking pawl.

In this case, joining work for joining the distal end edge of the aforesaid flap to the other side edge of the aforesaid slit opening becomes easy, and productivity can be improved.

### BRIEF DESCRIPTION OF THE DRAWINGS

FIG. 1 is a perspective view showing an exterior appearance of a fuse according to a first embodiment of the present invention;

FIG. 2 is a perspective view in section of the fuse as shown in FIG. 1.

FIG. 3 is a perspective view showing an exterior appearance of an essential part of a fuse according to a second embodiment of the invention.

FIG. 4 is a perspective view showing an exterior appearance of an essential part of a fuse according to a third embodiment of the invention.

FIG. 5 is a sectional view of a conventional fuse.

FIG. 6 is an enlarged sectional view of an essential part of the fuse as shown in FIG. 5.

### DETAILED DESCRIPTION OF THE PREFERRED EMBODIMENTS

Now, an embodiment of the invention will be described 20 in detail, referring to the attached drawings.

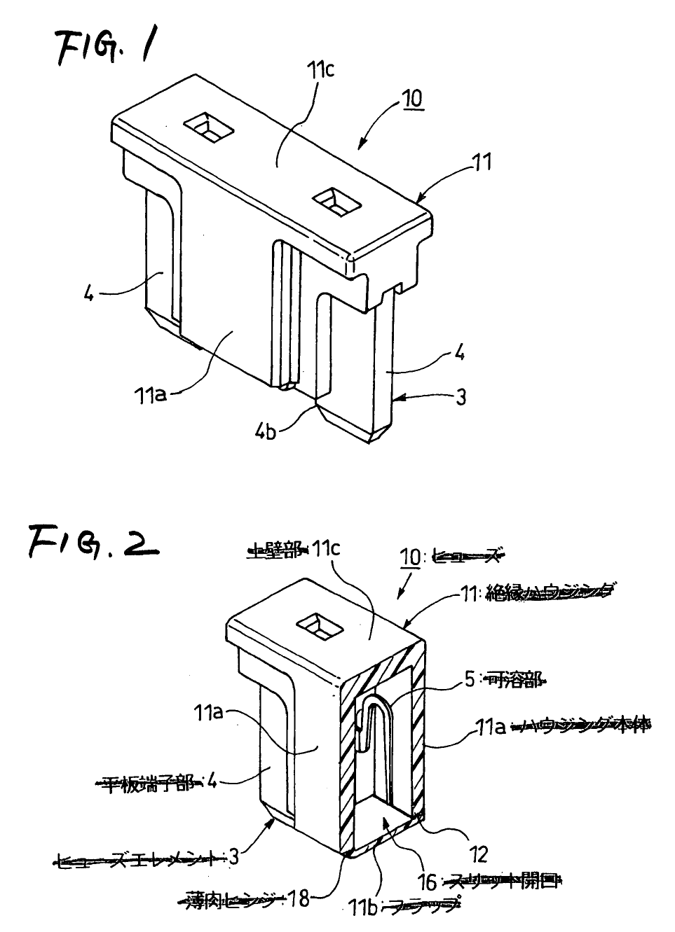

FIG. 1 is a perspective view showing an exterior appearance of a fuse according to a first embodiment of the invention, and FIG. 2 is a perspective view in section of the fuse as shown in FIG. 1. It is to be noted that since a fuse element in a 25 fuse 10 of this first embodiment has substantially the same structure as the fuse element 3 as shown in FIG. 5, the same components are denoted with the same reference numerals, and their detailed description will be omitted.

The fuse 10 in this first embodiment is a blade type fuse of low height which includes, as shown in FIGS. 1 and 2, a fuse element 3 having a fusible portion 5 provided between a pair of flat plate terminal portions 4, 4 arranged in parallel, and an insulating housing 11 made of synthetic resin in a T-shape which contains the fuse element 3.

The aforesaid insulating housing 11 which includes a pair of housing bodies 11a, 11a and an upper wall portion 11c mutually connecting upper ends of the housing bodies 11a, 11a is adapted to cover inner edges 4a and upper edges 4c of the aforesaid flat plate terminal portions 4, and the aforesaid fusible portion 5.

Moreover, on one side edge of a slit opening 16 formed at a lower end of the aforesaid insulating housing 11, a flap 11b which is integrally formed with the housing through a thin-walled hinge 18 is continuously provided so as to freely rotate, as shown in FIG. 2.

This flap 11b is rotated to a closed position in a state where the fuse element 3 has been inserted into the insulating housing 11 from the aforesaid slit opening 16, and locked to locking projections 4b which are projected from the aforesaid inner edges 4a of the respective flat plate terminal portions 4.

Further, the distal end edge of the aforesaid flap 11b which is abutted against the other side edge 12 of the aforesaid slit opening 16 (the lower end edge of the other housing body 11a) is joined by ultrasonic welding, thermal welding or the like, as shown in FIG. 2.

Specifically, according to the fuse 10 in this first embodiment, the flap 11b which is integrally formed with one of the housing bodies 11a (a frontward one in the drawings) through the thin-walled hinge 18 is joined to the lower end of the other housing body 11a (a backward one in the drawings) at its distal end edge, and therefore, it is possible to reliably hold the flap 11b in the closed state.

Therefore, in case where an outer force has been applied to the aforesaid flap 11b in a direction to open it, the flap 11b will not be displaced nor deformed so as to be easily opened, and the aforesaid fusible portion 5 can be reliably protected.

Moreover, because the slit opening 16 formed at the lower end of the aforesaid insulating housing 11 is reliably closed with the aforesaid flap 11b which is joined at its distal end edge, the insulating housing 11 will have a closed structure in section, and thus, strength of the insulating housing will be enhanced.

Consequently, by employing the aforesaid insulating housing 11 which has the enhanced strength, according to the fuse 10 in this first embodiment, protecting performance for the aforesaid fusible portion 5 can be enhanced.

Further, the structure including the fuse element, housing bodies, flap, and so on in the fuse according to the invention is not restricted to the structure in the above described embodiment, but it is needless to say that various forms can be employed on the basis of concept of the invention.

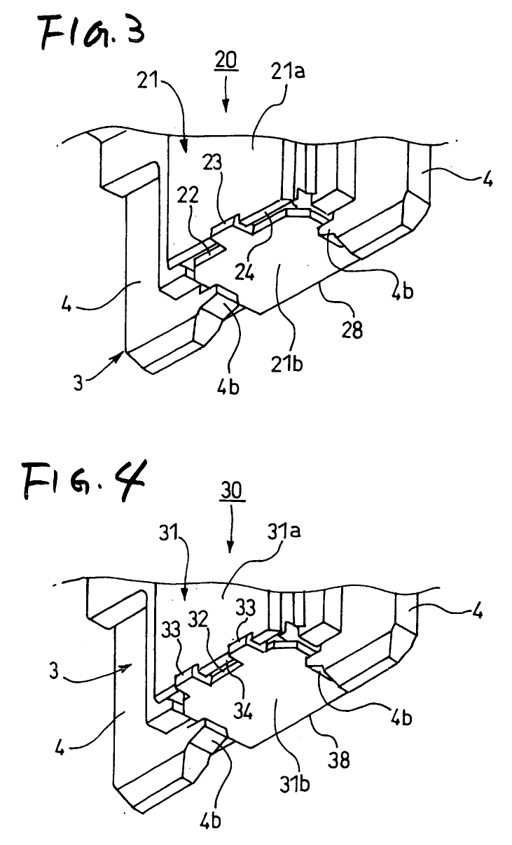

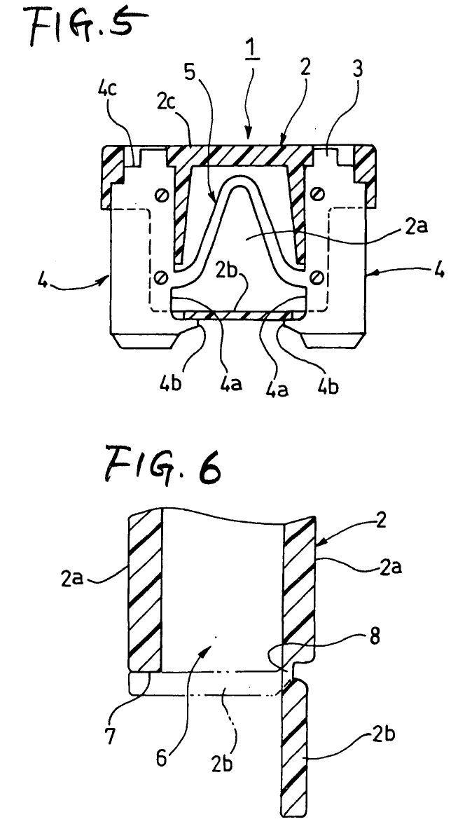

FIG. 3 is a perspective view showing an exterior appearance of an essential part of a fuse according to a second embodiment of the invention.

A fuse 20 in this second embodiment is a blade type fuse of low height which includes a fuse element 3 having a fusible portion 5 provided between a pair of flat plate terminal portions 4, 4 arranged in parallel, and an insulating housing 21 made of synthetic resin which contains the fuse element 3, similarly to the fuse 10 in the first embodiment as shown in FIG. 1.

As shown in FIG. 3, on one side edge of a slit opening formed at a lower end of the aforesaid insulating housing. 21, a flap 21b which is integrally formed with the housing through a thin-walled hinge 28 is continuously provided so as to freely rotate, and a locking pawl 23 is projected from a distal end edge 22 of the flap 21b.

The aforesaid flap 21b is rotated to a closed position in a state where the fuse element 3 has been inserted into the insulating housing 21 from the slit opening, and locked to the locking projections 4b which are projected from the aforesaid inner edges 4a of the respective flat plate terminal portions 4.

Moreover, the distal end edge 22 of the aforesaid flap 21b is joined in such a manner that the aforesaid locking pawl 23 is locked to the other side edge 24 of the above described slit opening (the lower end edge of the other housing body 21a) Therefore, also with the fuse 20 in this second embodiment, the protecting performance for the fusible portion 5 of the fuse element 3 which has been inserted into the insulating housing 21 can be enhanced, in the same manner as with the fuse 10 in the above described first embodiment.

FIG. 4 is a perspective view showing an exterior appearance of an essential part of a fuse according to a third embodiment of the invention. An insulating housing 31 of a fuse 30 according to this third embodiment is continuously provided, on one side edge of a slit opening formed at its lower end as shown in FIG. 4, with a flap 31b which is integrally formed with the housing through a thin-walled hinge 38 so as to freely rotate, and a pair of locking pawls 33, 33 are projected from a distal end edge 32 of the flap 31b.

The aforesaid flap 31b is rotated to a closed position in a state where the fuse element 3 has been inserted into the insulating housing 31 from the slit opening, and locked to the locking projections 4b which are projected from the aforesaid inner edges 4a of the respective flat plate terminal portions 4.

Moreover, the distal end edge 32 of the aforesaid flap 31b is joined in such a manner that a pair of the aforesaid locking pawls 33, 33 are locked to the other side edge 34 of the slit opening (the lower end edge of the other housing body 31a).

Therefore, also with the fuse 30 in this third embodiment, the protecting performance for the fusible portion 5 of the fuse element 3 which has been inserted into the insulating housing 31 can be enhanced, in the same manner as with the fuse 20 in the above described second embodiment.

Further, because the aforesaid locking pawls 33 are provided in a pair, it is possible to obtain a larger joining force than a locking force by means of the locking pawl 23 in the above described second embodiment.

It is to be noted that the flaps 21b, 31b according to the above described second and third embodiments can be joined only by locking the aforesaid locking pawls 23, 33 to the aforesaid side edges 24, 34 thereby to eliminate necessity of subsequent steps such as welding works, and assembling workability will be enhanced.

As described herein above, according to the fuse of the present invention, the flap which is integrally formed at the lower end of one of the housing bodies through the thin-walled hinge is joined to the lower end edge of the other housing body at its distal end edge, and accordingly, the flap can be reliably held in the closed state.

Therefore, in case where an outer force has been applied to the aforesaid flap, the flap will not be displaced nor deformed so as to be easily opened, and the fusible portion can be reliably protected.

Moreover, because the slit opening formed at the lower end of the aforesaid insulating housing is reliably closed with the aforesaid flap which is joined at its distal end edge, the insulating housing will have a closed structure in section, and thus, strength of the insulating housing will be enhanced.

Consequently, by employing the aforesaid insulating housing which has the enhanced strength, according to the fuse of the invention, the protecting performance for the aforesaid fusible portion can be enhanced.

What is claimed is:

1. A fuse comprising:
a fuse element including
a pair of flat plate terminal portions arranged in parallel,
a fusible portion provided between inner edges of said flat plate terminal portions; and
an insulating housing into which said fuse element is inserted so as to cover said inner edges and upper edges of said flat plate terminal portions and said fusible portion, said insulating housing including
a pair of housing bodies mutually connected at upper ends thereof so as to form a upper wall portion of said insulating housing,
an slit opening formed at a lower end of said insulating housing, and
a flap which is integrally formed at one side edge of said slit opening through a thin-walled hinge so as to be rotatable;
wherein a distal end edge of said flap is joined to another side edge of said slit opening.

2. A fuse as claimed in claim 1, wherein said distal end edge of said flap is joined to said another side edge of said slit opening by welding.

3. A fuse as claimed in claim 1, wherein said distal end edge of said flap is joined to said another side edge of said slit opening by at least one locking pawl.

4. A fuse as claimed in claim 1, wherein said distal end edge of said flap is joined to said another side edge of said slit opening by a pair of locking pawls.
